(19) United States
(12) Patent Application Publication
(10) Pub. No.: US 2022/0391922 A1
(43) Pub. Date: Dec. 8, 2022

(54) AUTOMATED DOCKETING CHECKER

(71) Applicant: Black Hills IP Holdings, LLC, Minneapolis, MN (US)

(72) Inventor: Steven W. Lundberg, Edina, MN (US)

(21) Appl. No.: 17/833,200

(22) Filed: Jun. 6, 2022

Related U.S. Application Data
(60) Provisional application No. 63/197,136, filed on Jun. 4, 2021.

(51) Int. Cl. G06Q 30/00; G06Q 50/26

(52) U.S. Cl. CPC G06Q 30/018; G06Q 50/26

(57) ABSTRACT

Various embodiments disclosed relate to an error detection tool for an electronic docketing system. The present disclosure includes methods and systems for reviewing and detecting an electronic docket for errors.

### CLAIM OF PRIORITY

This application claims the benefit of priority under 35 U.S.C. § 119(e) to U.S. Provisional Patent Application Ser. No. 63/197,136, filed on Jun. 4, 2021, which is incorporated by reference herein in its entirety.

### BACKGROUND

Docketing systems are often used for project management, such as in business and law firms. Such docketing system can include a combination of electronic programs and human docketers. In some cases, docketing system can be semi-automated or fully automated. Errors can occur during the docketing process.

### SUMMARY OF THE DISCLOSURE

The present disclosure provides methods and systems for automated docketing of incoming documents and tasks in project management. Project management, including docketing, can result in errors. Human error has historically occurred in docketing techniques. As more docketing is done in an automated or semi-automated manner with electronic tools and programs, errors can still occur when entries are received into the docketing system. In order to efficiently docket incoming documents and tasks, errors should be detected and addressed. The discussed methods and systems can allow for automated detection of docketing errors.

In an example, a method for identifying errors in entries in an electronic docket kept by an electronic docketing system, wherein the entries in the docketing system are created in response to electronic documents representing official communications generated by a government authority, can include obtaining an electronic document, automatically reading the electronic document to determine a docketing requirement for an entry to be made in the electronic docket corresponding to the electronic document, obtaining an electronic docketing report from the electronic docketing system, automatically determining if the electronic docketing report includes a docket item expected according to the docketing requirement and automatically generating an error report including an entry for any discrepancy notation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a flow chart of a method of detecting errors in a docketing system, in an example.

FIG. 2 illustrates a flow chart of a method of detecting errors in a docketing system, in an example.

FIG. 3 is a schematic diagram of a docketing system in an example.

FIG. 4 illustrates sample third party data sources that provide docketing data input for an automated docketing system implemented for managing patent portfolios in a sample embodiment.

FIG. 5 illustrates a block diagram of an example computing machine upon which any one or more of the techniques or methodologies discussed herein may be implemented.

### DETAILED DESCRIPTION

The present disclosure describes, among other things, discusses methods for detecting errors made in a document system, such as in a semi-automated or automated system, with the use of an automated error reporting tool.

As used herein, “electronic communication” refers to an electronic message or a method of exchanging messages between people using electronic devices.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

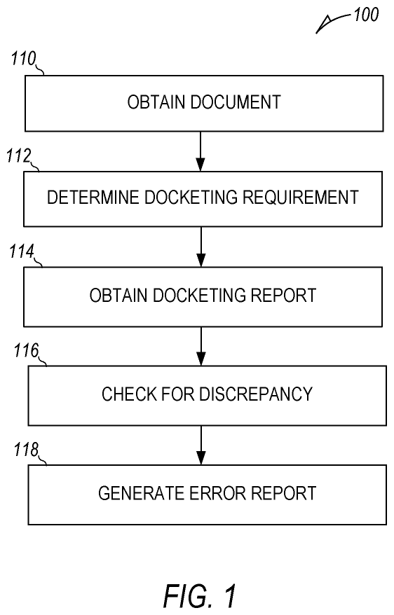

FIG. 1 illustrates a flow chart of a method 100 of detecting errors in a docketing system using an error detection tool. The method can include steps 110 to 118. The method 100 can be used, for example, to identify errors in specific entries into an electronic docket. The electronic docket can be kept by an electronic docketing system, such as a semi-automated or automated docketing system. In the docketing system, entries can be created in response to receipt of electronic documents. The electronic documents can include, for example, official communications from a governmental authority.

In step 110, the error detection tool can receive an electronic document. For example, the error detection tool can receive an electronic communication, such as an e-mail, with an attached electronic document for docketing. In some cases, the error detection tool can receive an electronic document scraped from an official database.

In step 112, the error detection tool can determine docketing requirements associated with the electronic document. The error detection tool can use a variety of techniques to determine one or more anticipated docketing requirements, such as those described in U.S. application Ser. No. 17/247,768 incorporated herein by reference in its entirety. The error detection tool can further determine the anticipated docketing requirements associated with a docketing entry based on that electronic communication.

In step 114, the error detection tool can receive a docketing report from the electronic docketing system. The docketing report can include information collected by the electronic docketing system regarding the incoming electronic communication, including docketed events or dates. The docketing report can include actual docketed events.

In step 116, the error detection tool can analyze the docketing report and determine whether it includes the expected docketing requirements. If there is a discrepancy, the error detection tool can produce an indication of an error. Finally, in step 118, the error detection tool can produce an error report detailing any discrepancies between the anticipated docketing requirements and the actual docketing report.

In some cases, the docketing requirement can specify a docket system code for the expected docket entry. The code can cause the docketing system to make an entry into the electronic docket.

In some cases, the error detection tool can further automatically determine a docket system code requirement corresponding with the electronic document. For example, this can be based on examining the docketing report and correlating a docketing code in the report to the electronic document.

In some cases, the error detection tool can further obtain metadata related to the electronic document. For example, the metadata can include a name of the electronic document, a code for the electronic document, and/or a date for the electronic document.

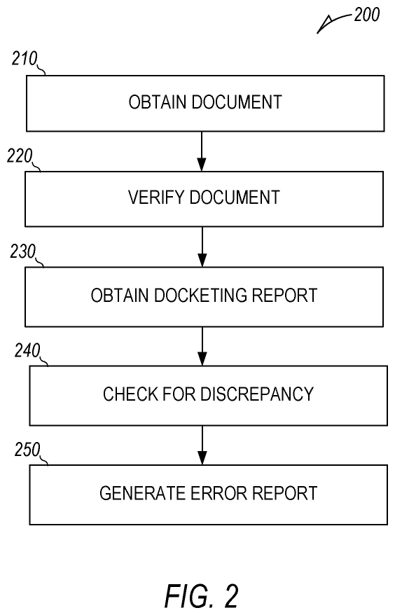

FIG. 2 illustrates a flow chart of a method 200 of detecting errors in a docketing system, in an example. The method 200 can include steps 210 to 250.

The method 200 can be for identifying errors in entries in an electronic docket kept by an electronic docketing system. Entries in the docketing system can be created in response to electronic documents representing official communications generated by a government authority.

First, at step 210, the electronic docketing system can obtain an electronic document.

Next, at step 220, the electronic docketing system can run a docket verification process. The docket verification process can include automatically reading the electronic document to determine a docketing requirement for an entry to be made in the electronic docket corresponding to the electronic document.

At step 230, the electronic docketing system can produce an electronic docketing report.

Then, at step 240, the electronic docketing report can be reviewed to determine if the electronic docketing report includes a docket item expected according to the docketing requirement and generating a discrepancy notation if the docket item is not on the report as expected.

The docket item on the electronic docketing report can be generated by the electronic docketing system using a rule, such as an action code or template, kept by the electronic docketing system. The docket item can specify a requirement and a due date for the requirement. The electronic docketing system can generate the docket item independently of the docket verification process.

The docketing requirement can specify a docket system code for the expected docketing entry. The code can cause the docketing system to make certain entries in the electronic docket. This can include automatically determining a docket system code requirement that corresponds to the electronic document based on examining the docketing report and correlating a docketing code used in the report that corresponds to the electronic document.

At step 250, the docketing system can automatically generate an error report including an entry for any discrepancy notation.

The docketing system can additionally obtain metadata about the electronic document from the government authority. The metadata can be a name of the electronic document, a code for the electronic document, and/or a date for the electronic document.

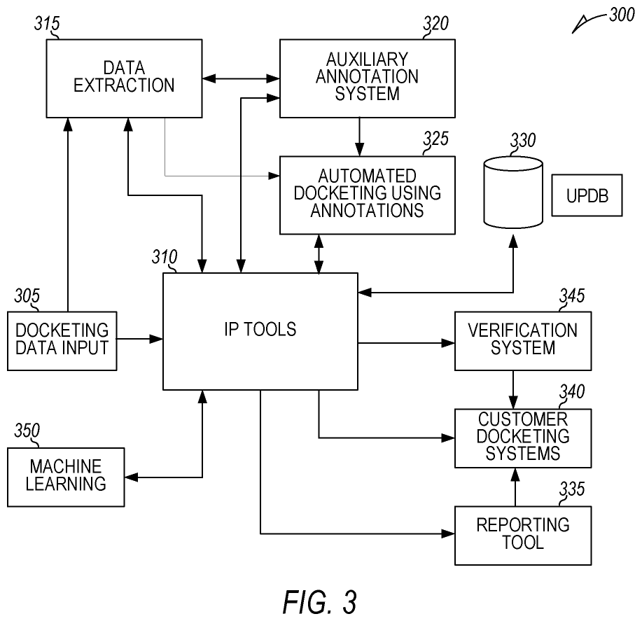

FIG. 3 is a block diagram of a docketing system 300 in an example. The docketing system 300 can be automated or semi-automated. The docketing system 300 can include docketing data input 305, docketing manger 310, data extraction 315, auxiliary annotation system 320, automated docketing using annotations 325, Universal Procedures Database 330, reporting tool 335, customer docketing system 340, verification system 345, and machine learning 350.

The automated docketing system 300 can receive documents from third party sources including third party docketing systems and/or customer data as docketing data input 305. The docketing manger system 310 can process the received documents to provide to the customer docketing systems 340 and prepare the documents for data extraction by the data extraction system 315 as needed.

The data extraction system 315 can perform Optical Character Recognition (OCR) on the received documents from the docketing manger system 310 to extract data, read checkboxes, extract lists, and identify documents where possible. The docketing manger system 310 can also integrate with a Universal Procedures Database (UPDB) 330 to provide automated docketing by an automated docketing tool 325 that processes received documents based on the additional annotations added to the documents based on the complex data extraction performed by the Auxiliary Annotation System (AAS) 320.

The AAS 320 may further identify the received documents without using an OCR. To manage this process, the docketing manger system 310 can receive frequent updates of docketing procedure rules including configuration data and updates the UPDB 330 with universal procedure codes (UPCs) as appropriate. The UPCs can be used in conjunction with customer specific codes, checklists, and templates. The rules can specify how to fill in the templates and how to complete customer-specific procedures such as how to docket documents into the customer's docketing system 340, for example. The template can be filled out by pulling in attributes from the annotations in a document.

The docketing manger system 310 can receive or intake documents and docketing data from several different sources of docketing data input 305, validate the docketing items against entries in a customer's docketing system 340, and communicate those documents to the customer's docketing system 340 via a unified interface. The docketing manger system 310 can also route documents and associated docketing data through the data extraction system 315 and the AAS 320 and organizes the returned metadata and annotations. The docketing manger system 310 thus can provide a breakout between the metadata and the document text.

The docketing manger system 310 can also keep records and communicate with third-party application programming interfaces (APIs) to push the docketing data and documents automatically where allowed. Otherwise, the docketing manger system 310 can present the documents to human docketers to docket. The docketing manager system 310 may also issue reports upon request.

The Docketing manger system 310 can be integrated with a customer's existing docketing system (e.g., Foundation IP), semi-integrated (e.g., CPI, Anaqua, etc.), may provide a virtual host that does not talk at all to the customer's existing docketing system (e.g., Lecopio, IP Manager, Memotech), or may provide outputs in spreadsheet form for use by a docketing administrator to update the customer's docking system 340.

If the Docketing manger system 310 and the customer's docketing system are not integrated, the data output of automated docketing system 300 may be presented to a human docketer for manual entry. For example, the human docketer may implement macros that interface with the customer's docketing system 340 to populate the received data into the customer's docketing system 340.

On the other hand, if the docketing manger system 310 and the customer's docketing system 340 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 330.

The automated docketing system 300 can also perform several post-docketing actions, such as sending docketing reports/details to an external verification system 345 that use a set of rules to verify proper docketing in a host system. The verification system 345 can verify that the data is correctly added to the external customer's docketing system 340. For example, the verification system 345 can pull data from the AAS 320, the docketing manger system 310, and the customer's docketing system 340 to compare what is present to what is expected to be present in the respective systems.

The automated docketing system 300 may also provide automated email “report out” notifications to customers by implementing a reporting tool 335 that specifies docketing actions based on UPDB template configurations. The reporting tool 335 can also provide completed docketing reports to customers either directly or via the customers' docketing system 340.

In some cases, machine learning techniques may be used to generate annotations. For example, a database of past documents that have been identified may be provided by the docketing manger system 310 and used as a data warehouse to train and improve machine learning models by creating a training set for the machine learning model. Over time, the machine learning model system 350 can learn which PTO IDs to use for which documents, which document in a bundle of documents may be used to characterize the bundle, and may provide predicted PTO IDs for the received documents. The machine learning model system 350 can also establish rule engine prediction capabilities for received documents that test the classifications.

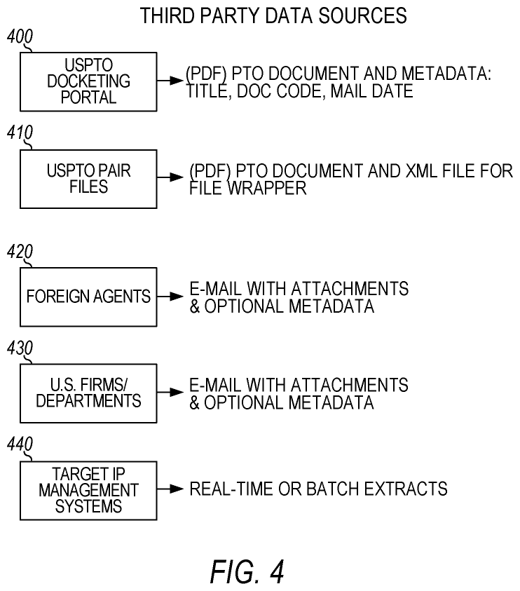

FIG. 4 illustrates sample third party data sources that provide docketing data input 305 for an automated docketing system 300 implemented for managing patent portfolios in an example. As illustrated in FIG. 4, the third party data sources may include the Patent Office (e.g., USPTO) docketing portal 400, which provides documents from the USPTO in portable document format (PDF) and includes metadata identifying the title, document code, and mail date for the corresponding document. The third party data sources may further include USPTO PAIR extensible markup language (XML) files 410, which provide documents from the USPTO in PDF and includes an XML file for patent file wrappers. The third party data sources may also include foreign agents 420 who provide emails with attachments and optional metadata. Foreign agents 420 may also provide hard copy documents that may be scanned for data entry. Similarly, law firms and/or corporate law departments 430 may provide emails with attachments and optional metadata as well as hard copy documents that may be scanned for data entry. Also, third party docketing systems 440 may provide real-time or batch extracts of data for entry into a docketing management system.

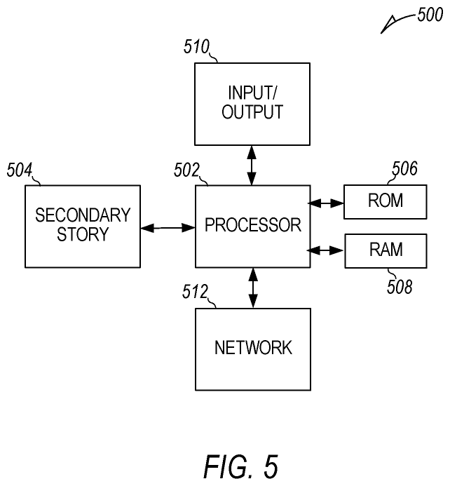

FIG. 5 illustrates a block diagram of an example computing system machine 500 upon which any one or more of the techniques (e.g., methodologies) discussed herein may perform. Machine 500 (e.g., computer system) may include a hardware processor 502 (e.g., a central processing unit (CPU), a graphics processing unit (GPU), a hardware processor core, or any combination thereof), a main memory 504 and a static memory 506, connected via an interconnect 508 (e.g., link or bus), as some or all of these components may constitute hardware for systems 100 or 200 or hardware to operate the services and subsystems and related implementations discussed above.

Specific examples of main memory 504 include Random Access Memory (RAM), and semiconductor memory devices, which may include, in some embodiments, storage locations in semiconductors such as registers. Specific examples of static memory 506 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 500 may further include a display device 510, an input device 512 (e.g., a keyboard), and a user interface (UI) navigation device 514 (e.g., a mouse). In an example, the display device 510, input device 512 and UI navigation device 514 may be a touch screen display. The machine 500 may additionally include a mass storage device 516 (e.g., drive unit), a signal generation device 518 (e.g., a speaker), a network interface device 520, and one or more sensors 530, such as a global positioning system (GPS) sensor, compass, accelerometer, or some other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 502 and/or instructions 524 may comprise processing circuitry and/or transceiver circuitry.

The mass storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage device 516 constitutes, in at least some embodiments, machine readable media.

The term “machine readable medium” includes, in some embodiments, any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Specific examples of machine readable media include, one or more of non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks. While the machine readable medium 522 is illustrated as a single medium, the term “machine readable medium” includes, in at least some embodiments, a single medium or multiple media (e.g., a centralized or distributed database, and/or associated caches and servers) configured to store the one or more instructions 524. In some examples, machine readable media includes non-transitory machine readable media. In some examples, machine readable media includes machine readable media that is not a transitory propagating signal.

The instructions 524 are further transmitted or received, in at least some embodiments, over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

An apparatus of the machine 500 includes, in at least some embodiments, one or more of a hardware processor 502 (e.g., a central processing unit (CPU), a graphics processing unit (GPU), a hardware processor core, or any combination thereof), a main memory 504 and a static memory 506, sensors 530, network interface device 520, antennas 532, a display device 510, an input device 512, a UI navigation device 514, a mass storage device 516, instructions 524, a signal generation device 518, and an output controller 528. The apparatus is configured, in at least some embodiments, to perform one or more of the methods and/or operations disclosed herein. The apparatus is, in some examples, a component of the machine 500 to perform one or more of the methods and/or operations disclosed herein, and/or to perform a portion of one or more of the methods and/or operations disclosed herein.

In an example embodiment, the network interface device 520 includes one or more physical jacks (e.g., Ethernet, coaxial, or phone jacks) or one or more antennas to connect to the communications network 526. In an example embodiment, the network interface device 520 includes one or more antennas 532 to wirelessly communicate using at least one of single-input multiple-output (SIMO), multiple-input multiple-output (MIMO), or multiple-input single-output (MISO) techniques. In some examples, the network interface device 520 wirelessly communicates using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as but not limited to read only memory (ROM); random access memory (RAM); magnetic disk storage media; optical storage media; flash memory, etc.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

### EXAMPLES

Each of these non-limiting examples can stand on its own, or can be combined in various permutations or combinations with one or more of the other examples.

Example 1 is a method for identifying errors in entries in an electronic docket kept by an electronic docketing system, wherein the entries in the docketing system are created in response to electronic documents representing official communications generated by a government authority, comprising a. Obtaining an electronic document; b. A docket verification process including automatically reading the electronic document to determine a docketing requirement for an entry to be made in the electronic docket corresponding to the electronic document; c. Obtaining an electronic docketing report from the electronic docketing system; d. Automatically determining if the electronic docketing report includes a docket item expected according to the docketing requirement and generating a discrepancy notation if the docket item is not on the report as expected; e. Wherein the docket item on the electronic docketing report is generated by the electronic docketing system using a rule (action code or template) kept by the electronic docketing system, and further wherein the docket item specifies a requirement and a due date for the requirement, and wherein the electronic docketing system generates the docket item independently of the docket verification process; and f. Automatically generating an error report including an entry for any discrepancy notation.

In Example 2, the subject matter of Example 1 optionally includes wherein the docketing requirement specifies a docket system code for the expected docketing entry, wherein the code causes the docketing system to make certain entries in the electronic docket.

In Example 3, the subject matter of Example 2 optionally includes automatically determining a docket system code requirement that corresponds to the electronic document based on examining the docketing report and correlating a docketing code used in the report that corresponds to the electronic document.

In Example 4, the subject matter of any one or more of Examples 1-3 optionally include obtaining metadata about the electronic document from the government authority.

In Example 5, the subject matter of Example 4 optionally includes wherein the metadata is a name of the electronic document, a code for the electronic document, and/or a date for the electronic document.

Example 6 is a computer readable medium comprising a memory and a processor, the processor configured to identify errors in entries in an electronic docket kept by an electronic docketing system, wherein the entries in the docketing system are created in response to electronic documents representing official communications generated by a government authority, the processor configured to perform the steps of: a. Obtaining an electronic document; b. A docket verification process including automatically reading the electronic document to determine a docketing requirement for an entry to be made in the electronic docket corresponding to the electronic document; c. Obtaining an electronic docketing report from the electronic docketing system; d. Automatically determining if the electronic docketing report includes a docket item expected according to the docketing requirement and generating a discrepancy notation if the docket item is not on the report as expected; e. Wherein the docket item on the electronic docketing report is generated by the electronic docketing system using a rule (action code or template) kept by the electronic docketing system, and further wherein the docket item specifies a requirement and a due date for the requirement, and wherein the electronic docketing system generates the docket item independently of the docket verification process; and f. Automatically generating an error report including an entry for any discrepancy notation.

In Example 7, the subject matter of Example 6 optionally includes wherein the docketing requirement specifies a docket system code for the expected docketing entry, wherein the code causes the docketing system to make certain entries in the electronic docket.

In Example 8, the subject matter of Example undefined optionally includes including automatically determining a docket system code requirement that corresponds to the electronic document based on examining the docketing report and correlating a docketing code used in the report that corresponds to the electronic document.

In Example 9, the subject matter of any one or more of Examples 6-8 optionally include obtaining metadata about the electronic document from the government authority.

In Example 10, the subject matter of Example 9 optionally includes wherein the metadata is a name of the electronic document, a code for the electronic document, and/or a date for the electronic document.

Example 11 is a method for identifying errors in entries in an electronic docket, the method comprising: obtaining an electronic docketing report from the electronic docket, the electronic docketing report including a docket requirement corresponding to an electronic document; determining whether the electronic docketing report includes a docket item expected according to the docketing requirement; generating a discrepancy notification if the docket item is not on the report as expected, wherein the docket item on the electronic docketing report is generated by the electronic docketing system using a rule kept by the electronic docketing system; and generating an error report including an entry for any discrepancy.

In Example 12, the subject matter of Example 11 optionally includes wherein the electronic docket is kept by an electronic docketing system.

In Example 13, the subject matter of any one or more of Examples 11-12 optionally include wherein the entries in the docketing system are created in response to electronic documents representing official communications generated by a government authority.

In Example 14, the subject matter of any one or more of Examples 11-13 optionally include obtaining an electronic document for verification.

In Example 15, the subject matter of Example 14 optionally includes verifying the electronic document prior to obtaining the electronic docketing report.

In Example 16, the subject matter of Example 15 optionally includes wherein verifying the electronic document comprises reading the electronic document to determine a docketing requirement for an entry to be made in the electronic docket corresponding to the electronic document.

In Example 17, the subject matter of any one or more of Examples 15-16 optionally include wherein verifying the electronic document is done automatically.

In Example 18, the subject matter of any one or more of Examples 11-17 optionally include wherein determining whether the electronic docketing report includes a docket item expected according to the docketing requirement is done automatically.

In Example 19, the subject matter of any one or more of Examples 11-18 optionally include wherein generating a discrepancy notation if the docket item is not on the report as expected is done automatically.

In Example 20, the subject matter of any one or more of Examples 11-19 optionally include wherein the rule is an action code or template kept by the electronic docketing system.

In Example 21, the subject matter of any one or more of Examples 11-20 optionally include wherein the docket item specifies a requirement and a due date for the requirement.

In Example 22, the subject matter of any one or more of Examples 11-21 optionally include wherein the electronic docketing system generates the docket item independently of the docket verification process.

In Example 23, the subject matter of any one or more of Examples 11-22 optionally include wherein generating an error report including an entry for any discrepancy is done automatically.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for identifying errors in entries in an electronic docket kept by an electronic docketing system, wherein the entries in the docketing system are created in response to electronic documents representing official communications generated by a government authority, comprising
a. Obtaining an electronic document;
b. A docket verification process including automatically reading the electronic document to determine a docketing requirement for an entry to be made in the electronic docket corresponding to the electronic document;
c. Obtaining an electronic docketing report from the electronic docketing system;
d. Automatically determining if the electronic docketing report includes a docket item expected according to the docketing requirement and generating a discrepancy notation if the docket item is not on the report as expected;
e. Wherein the docket item on the electronic docketing report is generated by the electronic docketing system using a rule (action code or template) kept by the electronic docketing system, and further wherein the docket item specifies a requirement and a due date for the requirement, and wherein the electronic docketing system generates the docket item independently of the docket verification process; and
f. Automatically generating an error report including an entry for any discrepancy notation.

2. The method according to claim 1 wherein the docketing requirement specifies a docket system code for the expected docketing entry, wherein the code causes the docketing system to make certain entries in the electronic docket.

3. The method according to claim 2 including automatically determining a docket system code requirement that corresponds to the electronic document based on examining the docketing report and correlating a docketing code used in the report that corresponds to the electronic document.

4. The method according to claim 1 further including obtaining metadata about the electronic document from the government authority.

5. The method according to claim 4 further wherein the metadata is a name of the electronic document, a code for the electronic document, and/or a date for the electronic document.

6. A computer readable medium comprising a memory and a processor, the processor configured to identify errors in entries in an electronic docket kept by an electronic docketing system, wherein the entries in the docketing system are created in response to electronic documents representing official communications generated by a government authority, the processor configured to perform the steps of:
a. Obtaining an electronic document;
b. A docket verification process including automatically reading the electronic document to determine a docketing requirement for an entry to be made in the electronic docket corresponding to the electronic document;
c. Obtaining an electronic docketing report from the electronic docketing system;
d. Automatically determining if the electronic docketing report includes a docket item expected according to the docketing requirement and generating a discrepancy notation if the docket item is not on the report as expected;
e. Wherein the docket item on the electronic docketing report is generated by the electronic docketing system using a rule (action code or template) kept by the electronic docketing system, and further wherein the docket item specifies a requirement and a due date for the requirement, and wherein the electronic docketing system generates the docket item independently of the docket verification process; and
f. Automatically generating an error report including an entry for any discrepancy notation.

7. The computer readable medium according to claim 6, wherein the docketing requirement specifies a docket system code for the expected docketing entry, wherein the code causes the docketing system to make certain entries in the electronic docket.

8. The computer readable medium according to claim 7 including automatically determining a docket system code requirement that corresponds to the electronic document based on examining the docketing report and correlating a docketing code used in the report that corresponds to the electronic document.

9. The computer readable medium according to claim 6, further including obtaining metadata about the electronic document from the government authority.

10. The computer readable medium according to claim 9, further wherein the metadata is a name of the electronic document, a code for the electronic document, and/or a date for the electronic document.

11. A method for identifying errors in entries in an electronic docket, the method comprising:
obtaining an electronic docketing report from the electronic docket, the electronic docketing report including a docket requirement corresponding to an electronic document;
determining whether the electronic docketing report includes a docket item expected according to the docketing requirement;
generating a discrepancy notification if the docket item is not on the report as expected,
wherein the docket item on the electronic docketing report is generated by the electronic docketing system using a rule kept by the electronic docketing system; and
generating an error report including an entry for any discrepancy.

12. The method of claim 11, wherein the electronic docket is kept by an electronic docketing system.

13. The method of claim 11, wherein the entries in the docketing system are created in response to electronic documents representing official communications generated by a government authority.

14. The method of claim 11, further comprising obtaining an electronic document for verification.

15. The method of claim 14, further comprising verifying the electronic document prior to obtaining the electronic docketing report.

16. The method of claim 15, wherein verifying the electronic document comprises reading the electronic document to determine a docketing requirement for an entry to be made in the electronic docket corresponding to the electronic document.

17. The method of claim 15, wherein verifying the electronic document is done automatically.

18. The method of claim 11, wherein determining whether the electronic docketing report includes a docket item expected according to the docketing requirement is done automatically.

19. The method of claim 11, wherein generating a discrepancy notation if the docket item is not on the report as expected is done automatically.

20. The method of claim 11, wherein the rule is an action code or template kept by the electronic docketing system.

21. The method of claim 11, wherein the docket item specifies a requirement and a due date for the requirement.

22. The method of claim 11, wherein the electronic docketing system generates the docket item independently of the docket verification process.

23. The method of claim 11, wherein generating an error report including an entry for any discrepancy is done automatically.
